(19) United States
(12) Patent Application Publication
(10) Pub. No.: US 2023/0043578 A1
(43) Pub. Date: Feb. 9, 2023

(54) TOUR GROUP MEMBER GATHERING DEVICE

(71) Applicant: LIQ MENG CORP., Taipei City (TW)

(72) Inventor: YEN-CHUAN LEE, TAIPEI CITY (TW)

(21) Appl. No.: 17/393,757

(22) Filed: Aug. 4, 2021

(51) Int. Cl. G01C 21/36; G06F 3/0482; H04L 12/18; H04L 12/58

(52) U.S. Cl. CPC G01C 21/3673; G06F 3/0482; H04L 12/1813; H04L 51/20; G06Q 50/30

(57) ABSTRACT

A tour group member gathering device includes a processing unit, an interface unit, a communication unit, and a map unit. The processing unit is connected to all units and controls all units accordingly. When the processing unit receives tour group member location information from the communication unit, the processing unit marks a current location and a tour group member location on map information generated by the map unit according to current location information and the tour group member location information. When marked event information is generated by the interface unit, the processing unit also generates a marked event location and a marked event message on the map information according to the marked event information. As the map information, the marked event information and the current location are displayed through the interface unit, a tour group member is able to effectively locate and communicate with other members of the tour group.

### BACKGROUND OF THE INVENTION

### 1. Field of the Invention

The present invention relates to a tour group member gathering device, more particularly a tour group member gathering device with generated map information.

### 2. Description of the Related Art

As living standards improve, more and more people fall in love with traveling overseas. However, regardless of traveling with friends, family, or a tour group, one can be possibly separated from his/her companions and get lost in a foreign country.

Assuming the worst circumstance where English is not used in the foreign country, one can find it difficult to decipher one's own whereabouts. Even though one may rely on a smart phone's map to locate oneself, one still does not know where other members of the traveling group are located.

More particularly, a lost member would need to contact a friend or a tour guide through the smart phone while switching applications to the map on the smart phone to locate everyone individually. After locating everyone, the lost member would still need to gauge how everyone is relatively located to the lost member himself/herself, in order to decide on a route to meet other members. Such way of communication is inconvenient, and allows a high chance of miscommunication about relative locations of each member, hindering effectiveness of finding the lost member.

Apart from being lost and being found, a member of the tour group can also be separated from other members during free activity time, when each member explores different parts of a foreign city independently. While exploring the city in the foreign country, the member may suddenly have an amazing discovery and wish to share the discovery with other members. However the member lacks the means to effectively communicate or locate a place of the discovery to other members, due to the aforementioned inconveniences of calling and switching applications on the smart phone to coordinate locations of others. As a result, the member would not be able to share the amazing discovery instantly, losing a chance of sharing ephemeral magical feelings of discovering.

### SUMMARY OF THE INVENTION

The present invention provides a tour group member gathering device, including an interface unit, a processing unit, a communication unit, and a map unit. The processing unit electrically connects the interface unit, the communication unit, and the map unit. The map unit generates map information and current location information.

When the processing unit receives tour group member location information from the communication unit, the processing unit marks a current location and a tour group member location on the map information according to the current location information and the tour group member location information. The processing unit then further displays the map information through the interface unit. When marked event information is generated by the interface unit, the processing unit also generates a marked event location and a marked event message on the map information according to the marked event information.

The tour group member gathering device of the present invention displays the current location and the tour group member location on the map, showing relative locations of the two. This way the present invention helps avoiding a situation that a tour member gets lost from a tour group in a foreign country. The present invention also announces the marked event information through the marked event location and the marked event message on the map information. This way the present invention also helps avoiding misunderstandings of a tour member for figuring out when and where a tour group gathering event is taking place.

### BRIEF DESCRIPTION OF THE DRAWINGS

FIG. 1 is a block diagram of an embodiment of a tour group member gathering device of the present invention.

FIG. 2 is a perspective view of map information in the embodiment of the present invention.

FIG. 3 is a perspective view of receiving a notification message as marked event information in the embodiment of the present invention.

FIG. 4 is a perspective view of receiving a confirmation for navigation route information from the navigation unit in the embodiment of the present invention.

FIG. 5 is a perspective view of a flow chart of receiving a picture message and navigating to a picture location in the embodiment of the present invention.

FIG. 6 is a flow chart of using the tour group member gathering device in the embodiment of the present invention.

FIG. 7A is a perspective view of tour group sharing information in the embodiment of the present invention.

FIG. 7B is a perspective view of tour group searching information in the embodiment of the present invention.

FIG. 8A is a perspective view of tour guide setting information in the embodiment of the present invention.

FIG. 8B is a perspective view of tour group member setting information in the embodiment of the present invention.

FIG. 9 is a perspective view of a tour group member stops updating his or her current location information.

### DETAILED DESCRIPTION OF THE INVENTION

The present invention provides a tour group member gathering device. The tour group member gathering device is a smart phone with a specific application (APP) in an embodiment of the present invention, and a person who uses the tour group member gathering device is either a tour guide or a tour group member in a tour group. The tour group member gathering device of the present invention helps either the tour guide or the tour group member to stay in contact with the rest of the tour group when travelling in a foreign country.

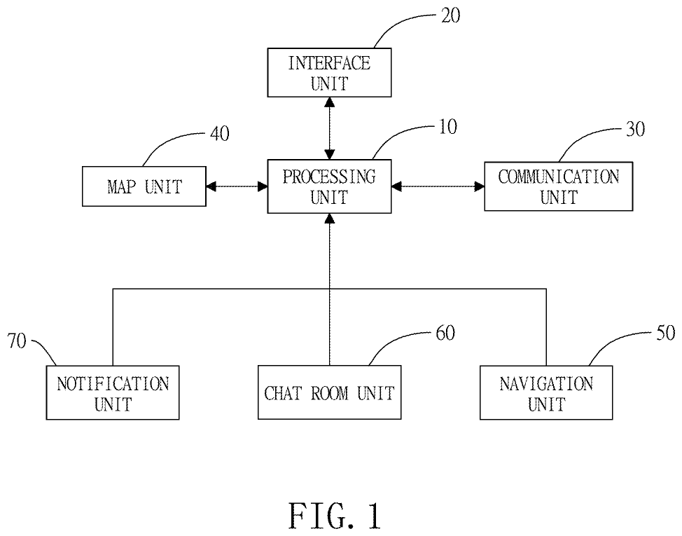

With reference to FIG. 1, in the embodiment of the present invention, the tour group member gathering device includes a processing unit 10, an interface unit 20, a communication unit 30, a map unit 40, a navigation unit 50, a chat room unit 60, and a notification unit 70. All units mentioned above electrically connect with the processing unit 10. The processing unit 10 controls all of the above units.

In the embodiment, the processing unit 10 is a processor of the smart phone, the interface unit 20 is a touch screen of the smart phone, and the communication unit 30 is a network communication unit of the smart phone. The interface unit 20 and the communication unit 30 are all well-known units, and therefore the two will be omitted from further discussing their functions.

The map unit 40 is electrically connected to the processing unit 10, and the map unit 40 generates map information and current location information. When the processing unit 10 receives a tour group member information through the communication unit 30, the processing unit 10 marks a current location and a tour group member location on the map information according to the current location information and the tour group member location information. The processing unit 10 then further displays the map information through controlling the interface unit 20. For example, the map unit 40 can be a Global Positioning System (GPS) unit of a smart phone.

In the embodiment, the current location represents a location of the tour group member gathering device, and the tour group member location represents locations of any other members of the tour group. The locations of any other members of the tour group can be located because all members of the tour group each have a respective smart phone with the same specific APP. Between the tour group member gathering devices, current location information can all be shared, marking locations of all members on the map information.

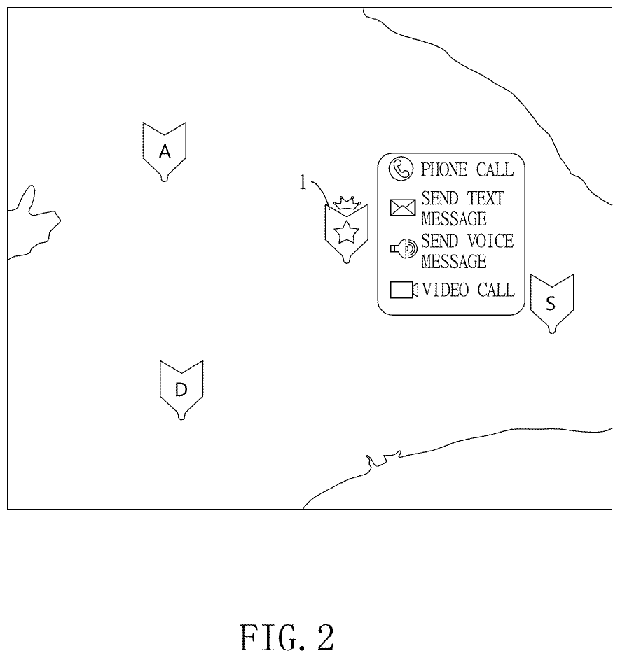

With reference to FIG. 2, FIG. 2 represents the map information displayed through the interface unit 20 of the present invention. Within the map information, symbol A represents a location of member A, symbol B represents a location of member B, and symbol S represents a location of member S. In the embodiment, alphabetical symbols A, D, S are assigned to the tour group members either according to chronological order of joining the tour group, or according to individual names of the tour group members. For instance, a first person to join the tour group will be member A, and a second person in accordance as member B. Or for instance, member A is taken as an initial of a name Adam, and member B is taken as an initial of a name Becky. The assignment of alphabetical or serial numbers to represent each of the tour group members is free to be other assigning methods.

When the interface unit 20 generates marked event information, the processing unit 10 generates a marked event location and a marked event message on the map information according to the marked event information. In the embodiment, the marked event information is any activities or events announced by the tour group. The activities or events, for instance, can be a dinner gathering with a specified time and location after free activity time of exploring a city in a foreign country. Further, the marked event location represents the location for dinner, and the marked event message can be a text message, a picture message, a video message, or an audio message describing detail about the dinner.

The processing unit 10 generates navigation route information based on the current location information and the marked event information through controlling the navigation unit 50. The navigation route information includes travel time information and travel distance information. Furthermore, the processing unit 10 also generates remaining time information based on current time and event time specified in the marked event message.

After the tour group member confirms about the marked event message, the present invention is able to navigate the tour group member to the marked event location. The navigation route information not only includes the travel time information and the travel distance information, but also includes a travel route to navigate to the marked event location. More particularly, when the processing unit 10 receives a selected command to the marked event from the interface unit 20, the processing unit 10 generates the navigation route information by controlling the navigation unit 50, and the processing unit 10 marks the travel route in the map unit 40.

The processing unit 10 of the present invention is able to detect the event time specified in the marked event message, and further generates the remaining time information according to the event time. The remaining time information helps the tour group member to understand how much time is left before the event starts. After the current time has passed the event time, the remaining time information is set to zero.

When the processing unit 10 determines a time difference between the travel time information and the remaining time information for the travel route is greater than a threshold value, the processing unit 10 concludes that time is ample before the event starts, and therefore a navigation is yet to activate unless specifically instructed to do so. The navigation is specifically instructed to activate by having the interface unit 20 receiving instructions from the tour group member and relaying the instructions to the processing unit 10.

When the processing unit 10 determines the time difference between the travel time information and the remaining time information for the travel route is less than the threshold value, the processing unit 10 concludes that time is little, and the processing unit 10 generates notification information. The notification information is displayed through the interface unit 20, and the notification information includes the travel time information, the travel distance information, and the remaining time information.

In the embodiment, the time difference is calculated by subtracting the travel time information from the remaining time information. The threshold value is greater than or equal to zero minute, and the threshold value is also adjustable by a device manager. For instance, when the time difference is less than 10 minutes, the processing unit 10 will generate the notification information.

When the remaining time information is greater than the travel time information, the notification information generated includes content asking the tour group member whether to start navigation to the marked event location after considering the travel time information, the travel distance information, and the remaining time information with the travel route. According to the tour group member's answer, the processing unit 10 will accordingly decide whether to activate the navigation or not. When the navigation is activated by the processing unit 10, in other words when the processing unit 10 controls the navigation unit 50 to enter the navigation, the navigation will either last until the destination is reached, or last until the interface unit 20 receives instructions telling the processing unit 10 to stop the navigation.

When the remaining time information is less than the travel time information, a situation can be either the following:

Situation 1, when an absolute value of the time difference is less than the threshold value, the processing unit 10 determines a late arrival is tolerable according to the threshold value, and therefore the processing unit 10 generates the notification information and additionally a notification message, telling the tour group members to hurry up against an impending lateness.

Situation 2, when the absolute value of the time difference is greater than the threshold value, the processing unit 10 determines an arrival is too late according to the threshold value, and therefore the processing unit 10 generates the notification information and additionally a notification message, instructing the tour group member to contact other members of the tour group for describing a circumstance surrounding the impending lateness.

In the embodiment, the processing unit 10 further generates a notification message through the notification unit 70 upon receiving a chat message from the communication unit 30. The notification message is generated according to the chat message received, and the notification message is displayed through the interface unit 20.

The notification unit 70 further determines whether the notification message is read. When the notification message is read, the interface unit 20 will display the chat message associated with the notification message, and the notification unit 70 will generate a read message. The read message will further be sent to other devices by the processing unit 10 via the communication unit 30, and when the processing unit 10 receives the read message through the communication unit 30, the processing unit 10 marks the chat message associated with the notification message as already read through in chat room information of the chat room unit 60.

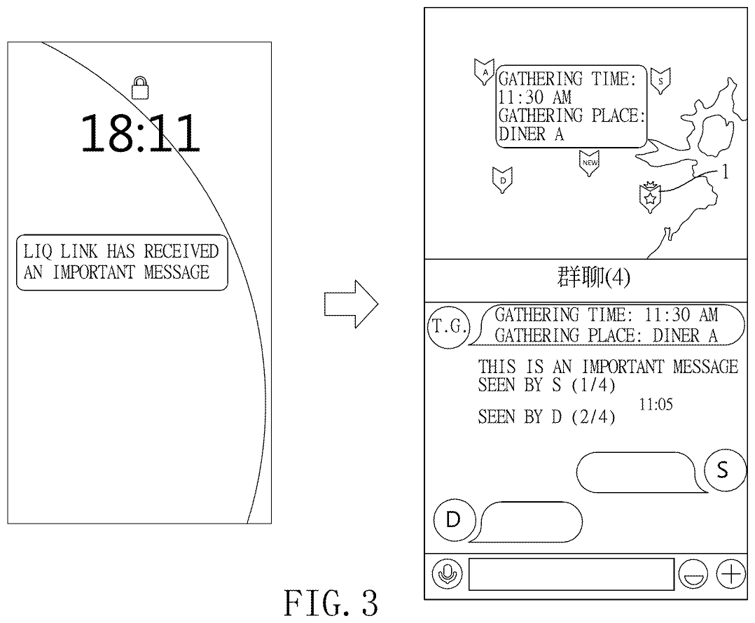

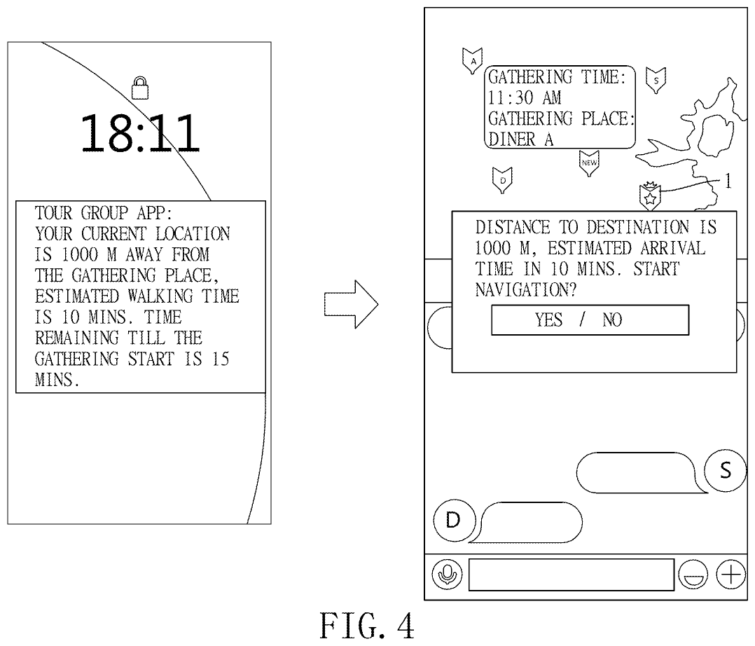

With reference to FIGS. 3 and 4, in the embodiment of the present invention, the generated notification message by the notification unit 70 is displayed by the processing unit 10 through the interface unit 20 on the smart phone's locked screen. When the locked screen of the smart phone is unlocked, the marked event information on the map information will accordingly display the marked event location and the marked event message, which in this case correspond to the specified time and location for dinner gathering. In the embodiment of the present invention, the marked event location where the dinner takes places is marked as NEW on the map, as the marked event information is relatively new. In other words, when a newer marked event information appears, the marked event information regarding the dinner would lose its NEW symbol on the map and be changed into another symbol representing the dinner event. Only the newest marked event information will be marked as NEW on the map, in other words, in any given time only one marked event information will be marked as NEW.

With reference to FIG. 3, the read message is displayed in the chat room information, detailing when the chat message is seen by each individual in the chat group, and also detailing a number of the tour group members who has seen the chat message. This way how many individuals the chat message or the announcement has reached can be tracked. In the embodiment, the announcement in FIG. 3 is displayed in a group chat room of the chat room unit 60. The group chat room is public, as opposed to a private chat room, belonging exclusively to those who join a private group within the tour group. The number displayed in FIG. 3 represents an amount of individuals who joined the chat group, in this case representing an amount of the tour group members in the tour group.

With reference to FIG. 4, when the processing unit 10 receives the selected command to the marked event from the interface unit 20, the navigation route information is displayed through the interface unit 20 on the smart phone's locked screen. Once the locked screen is unlocked, whether to start navigation to the event location is displayed through the interface unit 20.

The chat room information is generated according to the chat message by the chat room unit 60 controlled by the processing unit 10, and the chat room information is displayed through the interface unit 20 also controlled by the processing unit 10. The chat room information includes the chat message, and the chat message shares same format as the marked event message wherein both can be either a text message, a picture message, a video message, or an audio message. When the chat message is the picture message including a picture file, the processing unit 10 determines picture location information from the picture file. Based on the picture location information, the processing unit 10 would then mark a picture location on the map information.

In the embodiment, the processing unit 10 automatically determines the picture location information, marks the picture location on the map information, and also adds a text under the picture message detailing the location of the picture file. The picture file in this case happens to be a scenic photograph, and therefore the added text is written as photo location instead of picture location. When connected to the internet, the processing unit 10 would use search engines for pictures to help analyzing the picture file and marks the picture location on the map information.

Furthermore, when the processing unit 10 receives a picture selection command generated by the interface unit 20, the processing unit 10 controls the navigation unit 50 to generate navigation route information based on the current location information and the picture location information. The navigation route information is then marked in the map unit 40 by the processing unit 10, displaying the travel route in the map unit 40.

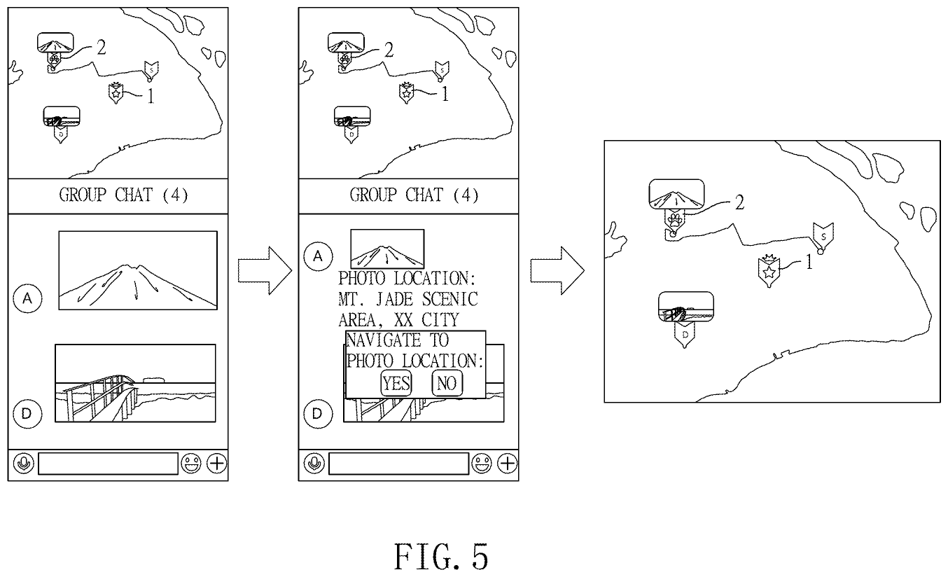

With reference to FIG. 5, as an example, when tour group member S receives picture messages from tour group member A and tour group member D, the marked event message would then be displayed on the map information as the two picture messages. The processing unit 10 determines the picture location of the picture message sent by the tour group member A, and proceeds to add texts under the corresponding picture message detailing the picture location. After the tour group member S selects the picture, the processing unit 10 asks the tour group member S whether to navigate to the picture location while displaying the travel route. The travel route starts from the current location of the group member S and ends at a destination marked as a footprint symbol 2. The footprint symbol 2 is where the picture is located on the map information.

Furthermore, in the embodiment of the present invention, the tour group consists of a tour guide and multiple tour group members. When the tour group is first created, the present invention provides the tour guide different device settings from the tour group members'. When the processing unit 10 determines tour guide setting information generated by the interface unit 20, the processing unit 10 receives tour group name information from the interface unit 20 and accordingly generates tour group sharing information. The tour group sharing information is displayed through the interface unit 20 controlled by the processing unit 10. In this case, the current location information is tour guide location information.

When the processing unit 10 determines tour group member setting information generated by the interface unit 20, the processing unit 10 receives tour group searching information from the interface unit 20, for searching tour groups related to the tour group searching information. In this case, the current location information is tour group member location information. The tour group searching information is either the tour group name information or the tour group sharing information. In the embodiment, the tour group sharing information is a Quick Response (QR) code.

With reference to FIG. 3, in the embodiment of the present invention, the alphabetical symbol T.G. represents the tour guide.

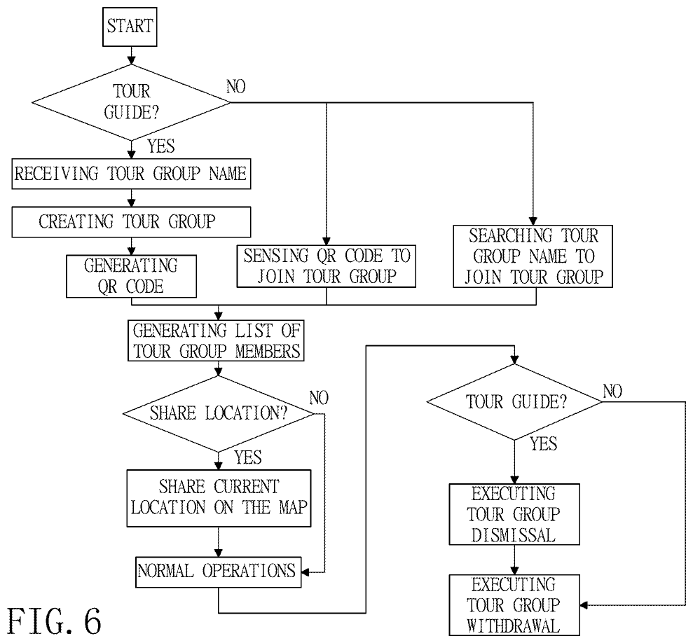

With reference to FIGS. 6 to 8B, FIG. 6 is a flow chart of using the tour group member gathering device in the embodiment of the present invention. Once the tour group member gathering device is started, the interface unit 20 provides options asking whether an individual is the tour guide.

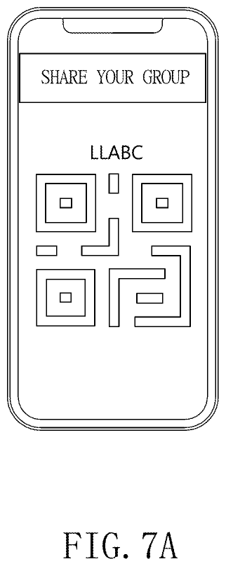

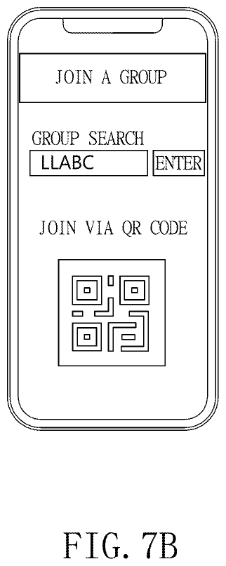

If the tour guide option is chosen, once the interface unit 20 generates the tour guide setting information, the interface unit 20 is displayed as shown in FIG. 7A, accepting the tour group name information for the processing unit 10 for naming the tour group. Once the processing unit 10 has created the tour group, the processing unit 10 controls the interface unit 20 to display the tour group sharing information as the QR code.

If another option is chosen instead of the tour guide option, then once the interface unit 20 generates the tour group member setting information, the interface unit 20 is displayed as shown in FIG. 7B, accepting the tour group searching information for the processing unit 10. The tour group searching information is either the tour group name information or the tour group sharing information, meaning that an individual can join a tour group to become a tour group member either through scanning a QR code, or through searching the corresponding tour group name in the present invention.

The interface unit 20 is only allowed to generate either the tour guide setting information or the tour group member setting information. Even though the interface unit 20 has generated the tour guide setting information, the processing unit 10 of the tour group member gathering device of the tour guide would still display the current location, as in this case the tour guide location information, on the map information. As demonstrated in FIGS. 2 to 5, a crowned star symbol 1 on the map information is the symbol representing the tour guide and the tour guide's location on the map information. In FIG. 2, once the crowned star symbol 1 is selected through the interface unit 20, or in other words once the tour group member selects the tour guide on the map information displayed by the interface unit 20, four options for using the communication unit 30 appear through the interface unit 20 beside the crowned star symbol 1. The four options from top to bottom accordingly represent options of phone calling, sending text messages in the chat room, sending audio messages in the chat room, and video calling. Phone calling and video calling are well known ways of communication, and sending text and audio messages in the chat room, as well as other forms of messages such as picture or video messages, are described as before, essentially detailing how the present invention is able to create the marked event location and the marked event message on the map information according to the chat message in the chat room, and how the present invention is able to provide an option of navigating from the current location to the marked event location.

In the embodiment, other than providing an option of navigating to the marked event location, the present invention also provides an option of navigating to any of the tour group members or to the tour guide. When any of the tour group members or the tour guide is selected in the chat room, the interface unit 20 provides options asking whether to navigate to the fellow tour group member or to the tour guide. When yes is selected, the processing unit 10 then controls the navigation unit 50 to generate the navigation route information from the current location to the fellow tour group member or to the tour guide. This way if one of the tour group members is lost and separated, the lost and separated tour group member is able to directly navigate himself/herself to be beside another tour group member or the tour guide.

With reference to FIG. 6, when the tour guide and the tour group members join the tour group, in the embodiment, the processing unit 10 generates a list of the tour group members, and the processing unit 10 further asks whether one is willing to share one's current location. If through the interface unit 20 one has chosen to share one's current location, the processing unit 10 then by default outputs the current location information for sharing among other tour group member gathering devices. If through the interface unit 20 one has chosen to refuse sharing one's current location, the processing unit 10 then stops outputting the current location information to others.

Once the settings are configured, the tour group member gathering device then enters normal operation regime. The normal operation regime is basically the aforementioned status of using the present invention for navigation, for communication, for sharing messages, and for accepting notifications. When normal operation regime ends, the tour group's adventure in the foreign country is near the end as well. The processing unit 10 once again generates different settings for the tour guide. According to earlier choices of whether an individual is a tour guide or not, the processing unit 10 controls the interface unit 20 accordingly providing different options.

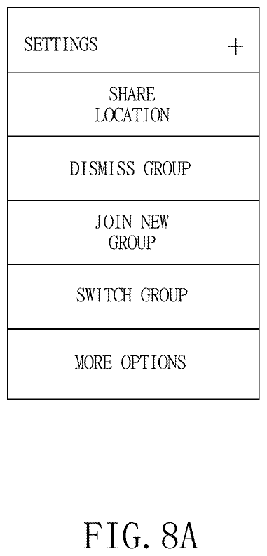

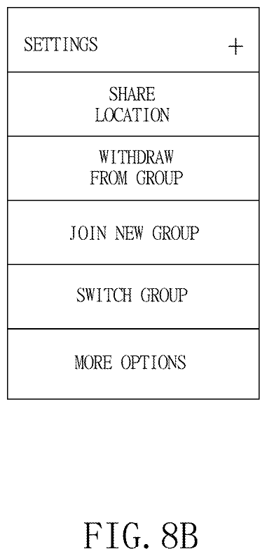

If the tour guide option is chosen, the interface unit 20 will be displayed as shown in FIG. 8A, wherein an option of dismissing the tour group is presented. Once the processing unit 10 receives a signal of dismissing the tour group generated from the interface unit 20, the processing unit 10 then proceeds to execute the dismissal of the tour group.

If another option is chosen rather than the tour guide option, the interface unit 20 will be displayed as shown in FIG. 8B, wherein an option of withdrawing from the tour group is presented. Once the processing unit 10 receives a signal of withdrawing from the tour group generated from the interface unit 20, the processing unit 10 then proceeds to execute the withdrawal from the tour group. In other words, the tour group members can self-withdraw from the tour group via the interface unit 20 of the present invention.

As shown in FIGS. 8A and 8B, in the embodiment the interface unit 20 not only provides an option of sharing the current location, but also options of joining new tour group and switching between tour groups. Based on signals created by the interface unit 20, the processing unit 10 can accordingly let the individual join a new tour group, allowing the individual to simultaneously join multiple tour groups and switching between tour groups, with different sets of settings accordingly loaded into the tour group member gathering device.

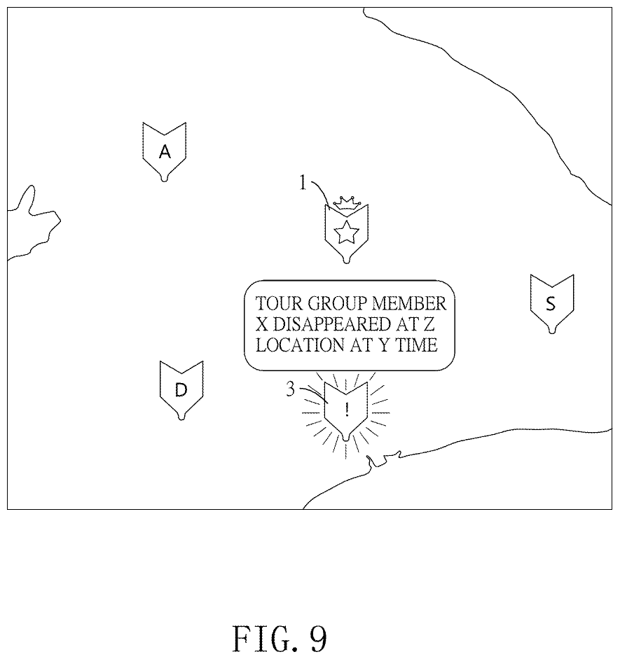

With reference to FIG. 9, after the processing unit 10 determined tour guide setting information generated by the interface unit 20, when the processing unit 10 receives the tour group member location information from the communication unit 30, and finds out current location information of another tour group member gathering device stops updating in the map information, the processing unit 10 accordingly generates the marked event information.

In other words, when the tour group member gathering device of the present invention belongs to the tour guide, and when the present invention discovers that one of the tour group members with the other tour group member gathering device stops updating his or her current location information, the present invention will leave a record regarding an absent of the tour group member by generating the marked event information. The processing unit 10 then controls the interface unit 20 to display the marked event location as a last updated location of the other tour group member gathering device in the map information, and controls the interface unit 20 to display the marked event message regarding an absent of update from the other tour group member gathering device as a missing person message. The last updated location of the other tour group member gathering device is marked as an exclamation mark 3 in FIG. 9. Furthermore as shown in FIG. 9, a format of the missing person message can be, for instance, tour group member X disappeared at Z location at Y time.

The absent of update from the other tour group member gathering device mentioned above, in reality can result from scenarios such as:

the other tour group member gathering device ran out of battery;

the other tour group member gathering device withdrew from the tour group and stopped sharing the current location information; or

the other tour group member gathering device stopped sharing the current location information as the tour group member refused to share the current location information via the interface unit 20.

What is claimed is:

1. A tour group member gathering device, comprising:
an interface unit;
a processing unit, electrically connecting the interface unit;
a communication unit, electrically connecting the processing unit;
a map unit, electrically connecting the processing unit, and generating map information and current location information; wherein
when the processing unit receives tour group member location information from the communication unit, the processing unit marks a current location and a tour group member location on the map information according to the current location information and the tour group member location information; the processing unit then further displays the map information through the interface unit; and
when the interface unit generates marked event information, the processing unit also generates a marked event location and a marked event message on the map information according to the marked event information.

2. The tour group member gathering device as claimed in claim 1, further comprising:
a navigation unit, electrically connecting the processing unit; wherein
the processing unit controls the navigation unit to generate navigation route information according to the current location information and the marked event information; the navigation route information includes travel time information and travel distance information;
the processing unit also generates remaining time information based on a current time and an event time specified in the marked event message; and
when the processing unit determines a time difference between the travel time information and the remaining time information for a travel route is less than a threshold value, the processing unit generates notification information;
the notification information is displayed through the interface unit, and the notification information includes the travel time information, the travel distance information, and the remaining time information.

3. The tour group member gathering device as claimed in claim 2, wherein when the processing unit receives a selected command to the marked event from the interface unit, the processing unit generates the navigation route information by controlling the navigation unit and the processing unit marks the travel route in the map unit.

4. The tour group member gathering device as claimed in claim 1, further comprising:
a chat room unit, electrically connecting the processing unit; wherein
when the processing unit receives a chat message through the communication unit, the processing unit controls the chat room unit to generate chat room information according to the chat message received; the chat room information is then displayed through the interface unit; and
when the chat room message has a picture file, the processing unit determines picture location information from the picture file; and based on the picture location information, a picture location is accordingly marked on the map information by the processing unit.

5. The tour group member gathering device as claimed in claim 4, further comprising:
a navigation unit, electrically connecting the processing unit; wherein
when the processing unit receives a picture selection command generated by the interface unit, the processing unit controls the navigation unit to generate navigation route information based on the current location information and the picture location information; the navigation route information is then marked in the map unit by the processing unit as a travel route.

6. The tour group member gathering device as claimed in claim 1, wherein
when the processing unit determines tour guide setting information generated by the interface unit, the processing unit receives tour group name information from the interface unit and accordingly generates tour group sharing information; the tour group sharing information is displayed through the interface unit controlled by the processing unit; and
the current location information is tour guide location information.

7. The tour group member gathering device as claimed in claim 6, wherein
when the processing unit determines tour group member setting information generated by the interface unit, the processing unit receives tour group searching information from the interface unit for searching tour groups related to the tour group searching information;
the current location information is the tour group member location information; and
the tour group searching information is either the tour group name information or the tour group sharing information.

8. The tour group member gathering device as claimed in claim 7, wherein
the tour group sharing information is a Quick Response (QR) code.

9. The tour group member gathering device as claimed in claim 4, further comprising:
a notification unit, electrically connecting the processing unit; wherein
when the processing unit receives the chat message through the communication unit, the processing unit controls the notification unit to generate a notification message according to the chat message; the notification message is then displayed through the interface unit.

10. The tour group member gathering device as claimed in claim 9, wherein
the notification unit further determines whether the notification message is read;
if the notification message is read, the notification unit generates a read message, and the read message is delivered through the communication unit; and
when the processing unit receives the read message through the communication unit, the processing unit marks the chat message associated with the notification message as already read through in the chat room information of the chat room unit.

11. The tour group member gathering device as claimed in claim 6, wherein
after the processing unit determined tour guide setting information generated by the interface unit, when the processing unit receives the tour group member location information from the communication unit, and finds out current location information of another tour group member gathering device stops updating in the map information, the processing unit accordingly generates the marked event information;
the processing unit then controls the interface unit to display the marked event location as a last updated location of the other tour group member gathering device in the map information, and controls the interface unit to display the marked event message regarding an absent of update from the other tour group member gathering device as a missing person message.
